(19) United States
(12) Patent Application Publication
(10) Pub. No.: US 2012/0231413 A1
(43) Pub. Date: Sep. 13, 2012

(54) ENDODONTIC INSTRUMENT AND METHOD OF MANUFACTURING

(76) Inventors: John T. McSpadden, Lookout Mountain, TN (US); Vinod Sikka, Oak Ridge, TN (US)

(21) Appl. No.: 13/408,562

(22) Filed: Feb. 29, 2012

Related U.S. Application Data
(60) Provisional application No. 61/451,858, filed on Mar. 11, 2011.

(51) Int. Cl. A61C 5/02; B26D 3/16; B23P 15/42; B26D 3/00

(52) U.S. Cl. 433/102; 29/896.1; 29/2.25

(57) ABSTRACT

An endodontic instrument for use in a root canal procedure. The instrument is formed from a substantially hollow tube with at least one elongate slotted aperture extending along a portion of a length of the tube. One or more of the edges of the slotted aperture provide cutting surfaces for extirpating material from the walls of a root canal.

### CROSS REFERENCE TO RELATED APPLICATIONS

This application claims priority under 35 U.S.C. §119(c) to provisional application Ser. No. 61/451,858, filed Mar. 11, 2011, which is incorporated herein by reference.

### FIELD

This disclosure relates to the field of medicine and dentistry. More particularly, this disclosure relates to endodontic instruments.

### BACKGROUND

In the field of endodontics, one of the most important and delicate procedures is that of cleaning or extirpating a root canal to provide a properly dimensioned cavity while essentially maintaining the central axis of the canal. This step is important in order to enable complete filling of the canal without any voids and in a manner which prevents the entrapment of noxious tissue in the canal as the canal is being filled.

In a root canal procedure, the dentist removes injured tissue and debris from the canal prior to filling the canal with an inert filling material. In performing this procedure the dentist must gain access to the entire canal, shaping it as necessary. But root canals normally are very small in diameter, and they are usually quite curved. It is therefore very difficult to gain access to the full length of a root canal.

Many tools have been designed to perform the difficult task of cleaning and shaping root canals. Historically, dentists have used a wide multitude of tools to remove the soft and hard tissues of the root canal. Traditionally, these tools, usually called endodontic files, have been made by three basic processes. In one process, a file is created by twisting a prismatic rod of either square or triangular cross section in order to create a file with helical cutting/abrading edges (“K-file”). The second process involves grinding helical flutes into a circular or tapered rod to create a file with one or more helical cutting edges (“Hedstrom file”). The third method involves “hacking” or rapidly striking a circular or tapered rod with a blade at a given angle along the length of the rod, thus creating an endodontic file characterized by a plurality of burr-like barbs or cutting edge projections (“barbed file” or “broach”). Each of these methods produces an instrument having unique attributes, advantages, and disadvantages.

Endodontic files have historically been made from stainless steel, but due to the inherent stiffness and brittleness of steel, these tools can sometimes pose a significant danger of breakage in the curved root canal. More recent designs have attempted to overcome these problems. Some attempt to alter the geometry of the stainless steel file or use a more flexible material, such as nickel-titanium alloys, in order to provide more flexibility. While these approaches have improved the performance of endodontic files, the files still have a tendency to break if over-torqued or fatigued.

Additionally, when a helically fluted endodontic file is used to extirpate a canal, debris tends to accumulate in the helical flutes as the procedure progresses. This accumulated debris can decrease the files efficiency and can eventually prevent the cutting edges on the file from engaging the canal wall. One method for alleviating the debris accumulation is frequent irrigation of the canal. In certain instances, it is preferable to irrigate the canal simultaneously with the extirpation process. However, this can be difficult when the canal is substantially filled with an endodontic file.

What is needed, therefore, is a different geometric approach to create an endodontic instrument which would fare better with regard to torque stresses, fatigue, and other related stresses on such an instrument, limit debris accumulation, and allow for irrigation simultaneously with extirpation of a root canal. Additionally, what are needed are new methods for manufacturing endodontic instruments with such desirable characteristics.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a somewhat schematic side view of an embodiment of an endodontic instrument;

FIG. 2 shows a somewhat schematic side view of an embodiment of a cylindrically-shaped portion of an endodontic instrument before fabrication;

FIG. 3 shows a somewhat schematic side view of a different embodiment of a cylindrically-shaped portion of an endodontic instrument after apertures have been cut therein;

FIG. 4 shows a somewhat schematic side view of another embodiment of a cylindrically-shaped portion of an endodontic instrument after apertures or slits have been cut therein;

FIG. 5 shows a somewhat schematic side view of the cylindrically-shaped portion of an endodontic instrument shown in FIG. 4 after a plunger has been inserted therein;

FIG. 6 shows a somewhat schematic side view of the cylindrically-shaped portion of an endodontic instrument shown in FIG. 5 after a brace has been attached thereto;

FIG. 7 shows a somewhat schematic side view of the cylindrically-shaped portion of an endodontic instrument shown in FIG. 5 after a cutting tip has been attached thereto;

FIG. 8 shows a somewhat schematic side view of an embodiment of a cylindrically-shaped portion of an endodontic instrument showing shaded areas where material may be removed to form a cutting tip;

FIG. 9 shows a somewhat schematic side view of the embodiment of a cylindrically-shaped portion of an endodontic instrument shown in FIG. 8 wherein the view in FIG. 9 is rotated approximately 90 degrees relative to the view shown in FIG. 8;

FIG. 10 shows a somewhat schematic side view of an embodiment of an endodontic instrument similar to the embodiment shown in FIGS. 1-2, but including multiple “V-shaped” notches cut from a hollow cylindrical tube;

FIG. 11 shows a somewhat schematic view of an embodiment of a hollow tube including a helical slit along its length; and

FIG. 12 shows a somewhat schematic view of the tube of FIG. 11 having been stretched and heated to form an endodontic instrument.

### DETAILED DESCRIPTION

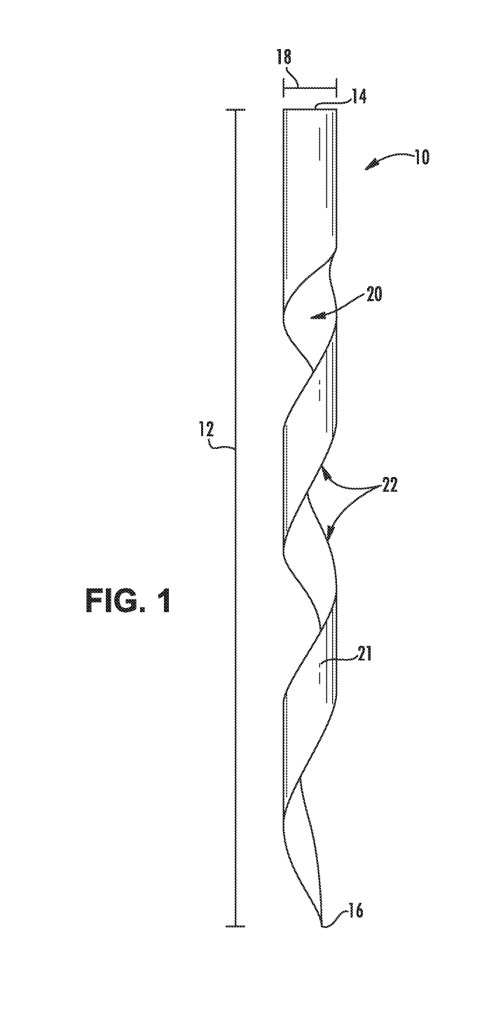

FIG. 1 shows a preferred embodiment of an endodontic instrument 10 having a length 12 preferably ranging from about 20 mm to about 35 mm and more preferably from about 25 mm to about 30 mm, said length 12 extending from a proximal end 14 to a distal end 16 of the instrument 10. In certain embodiments, a handle (not shown) may be attached to the proximal end of the instrument 10 for manual manipulation or for removable attachment to an automated rotary device. The instrument 10 has a width 18 preferably ranging from about 5×10⁻¹ mm to about 1.25 mm and more preferably ranging from about 6.5×10⁻¹ mm to about 1.15 mm. The instrument 10 is preferably formed by cutting notches, e.g. removing strips from the tube, having a defined shape from a hollow cylindrical tube to create at least one channel 20 and at least one land 21, the edges of which define cutting edges 22. In a preferred embodiment, the cylindrical tube is made from stainless steel, nickel titanium alloys, or other suitable metal or composite materials. The cylindrical walls of the tube preferably have a thickness ranging from about 2×10⁻¹ mm to about 7×10⁻¹ mm.

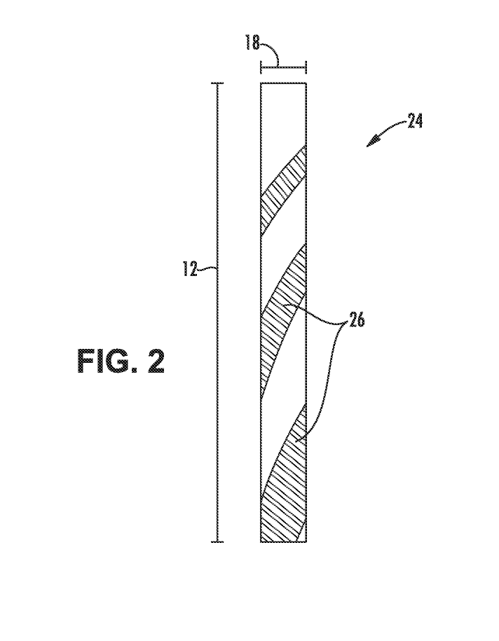

FIG. 2 shows an embodiment of a cylindrical tube 24 having the length 12 and the width 18. The pattern 26 shown on the surface of the cylindrical tube 24 represents an area that may be cut away to form an embodiment of an endodontic instrument similar to the endodontic instrument shown in FIG. 1. Preferably, the pattern 26 includes a substantially “V” shaped notch which is cut in a helical pattern along the length of the cylindrical tube 24. In a preferred embodiment, the notch extends in V-shaped fashion from a point adjacent the proximal end of the cylindrical tube 24, expanding in width as it advances towards the distal end of the tube. At the distal end of the cylindrical tube, the width of the V-shaped notch has increased such that the distal end of the land 21 ends in a tip 16. The land 21 preferably extends from the tip 16 adjacent the distal end at an angle ranging from about 4 degrees to about 9 degrees.

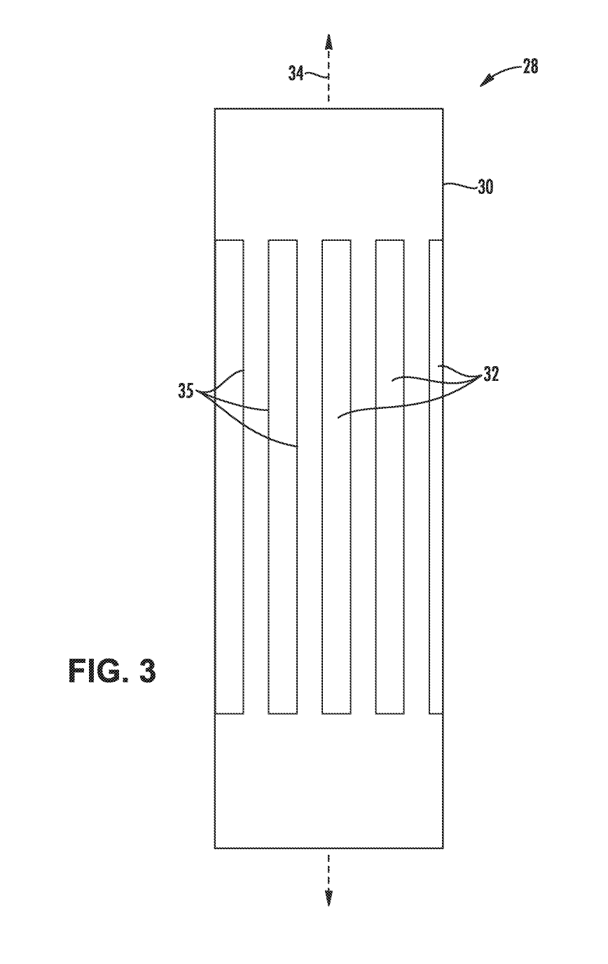

FIG. 3 shows another embodiment of relevant portions of an endodontic instrument 28 including a hollow cylindrical working portion 30 and a plurality of elongated apertures 32 oriented substantially along the length axis 34 of the instrument 28. In one embodiment the apertures 32 may be in the form of narrow slits, wherein the slits may be as narrow as, for example, 1/1000 mm in width. In a preferred embodiment, the elongated apertures 32 extend substantially parallel to the length axis 34. However, in alternate embodiments, the elongated apertures 32 are angled with respect to the length axis 34 such they extend along the instrument in a substantially helical fashion. The apertures 32 are preferably created by cutting from a cylindrical tube and the edges 35 of the apertures act as cutting edges when the working portion 30 is rotated along its length axis 34 in a root canal.

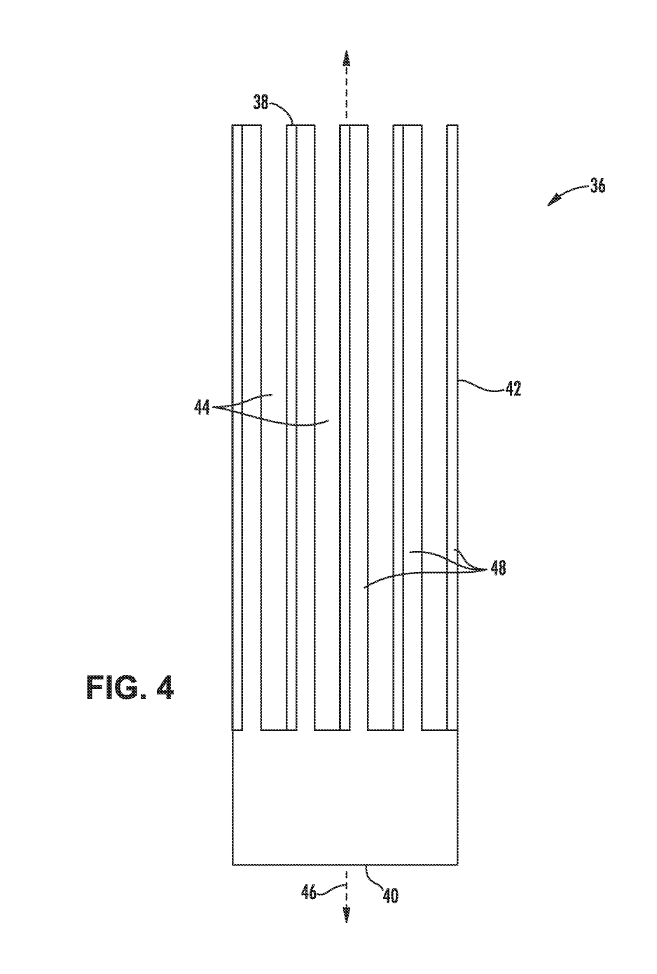

FIG. 4 shows a related embodiment of an unfinished endodontic instrument 36, the instrument 36 including a proximal end 38 and a distal end 40. The instrument 36 shown in FIG. 4 further includes a hollow cylindrically-shaped base 42 and a plurality of elongated apertures 44 oriented substantially along the length axis 46 of the instrument 36 and extending from the proximal end 38 of the base 42, thereby defining a plurality of arms 48.

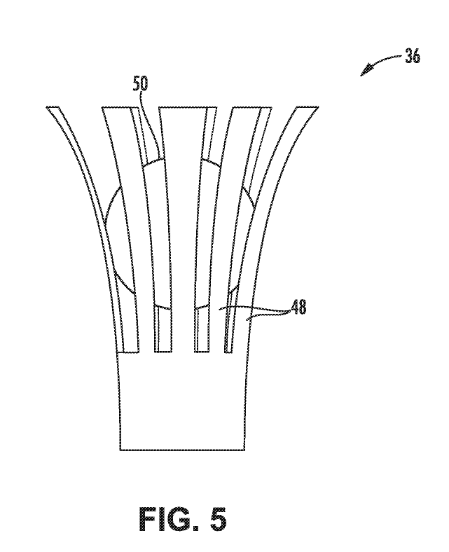

FIG. 5 shows the unfinished instrument 36 from FIG. 4 and further illustrates the use of a plunger 50 to spread the plurality of arms 48 outwardly. The diameter of the plunger is preferably greater than the inside diameter of the cylindrically-shaped base 42. The plunger 50 preferably includes a metallic sphere or other curved shape to facilitate forcing each of the arms 48 outward in a substantially similar manner, angle, and distance and, preferably, at substantially the same time.

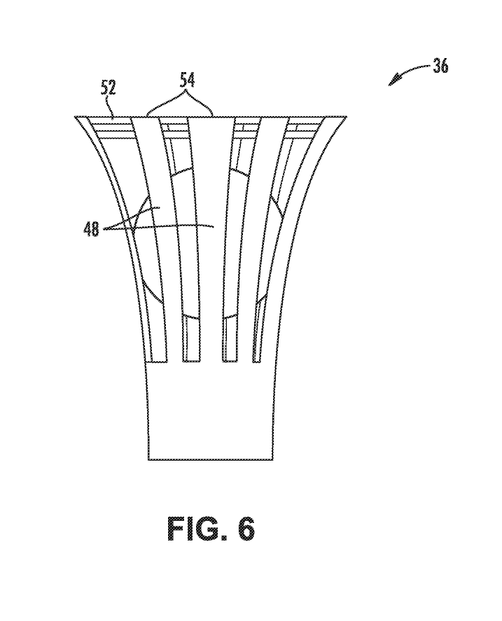

FIG. 6 shows the instrument 36 after plunging and further shows the addition of a brace 52 attached to proximal ends 54 of at least two of the arms 48. The brace 52 is preferably in the shape of a circle, an oval, or a polygon. The brace 52 may, for example, include or otherwise be attached to a handle allowing a user to manipulate the instrument 36 during, for example, an endodontic medical procedure. The brace 52 may, as another example, include a means for attachment to a rotary and/or reciprocating device such as, for example, a dental drill. The edges of the arms 48 serve as cutting edges when the instrument 36 is rotated and/or reciprocated within a root canal. In certain embodiments, the edges of the arms are cut perpendicular to the length axis of the instrument 36. In various alternate embodiments, the edges may be angled to the length axis to enhance extirpation of material from the walls of the canal.

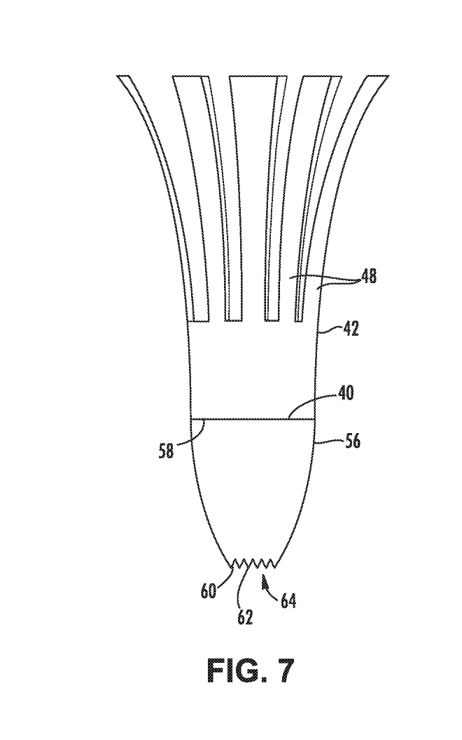

FIG. 7 shows the base 42 attached to a cutting tip 56 including a proximal end 58 and a distal end 60. The proximal end 58 of the cutting tip 56 is attached adjacent the distal end 40 of the base 42. The cutting tip 56 may come in various shapes, such shapes preferably including a tapering tendency, for example, the tapering of a conical shape as shown in FIG. 7. The cutting tip 56 may include additional features including, for example, one or more cutting edges 62 or one or more apertures 64.

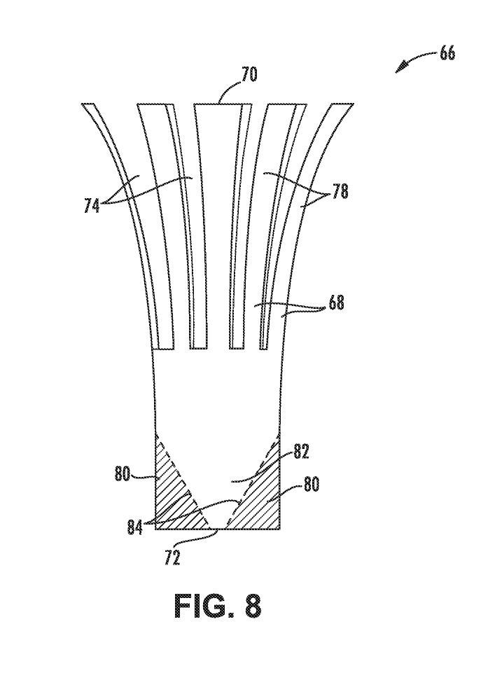

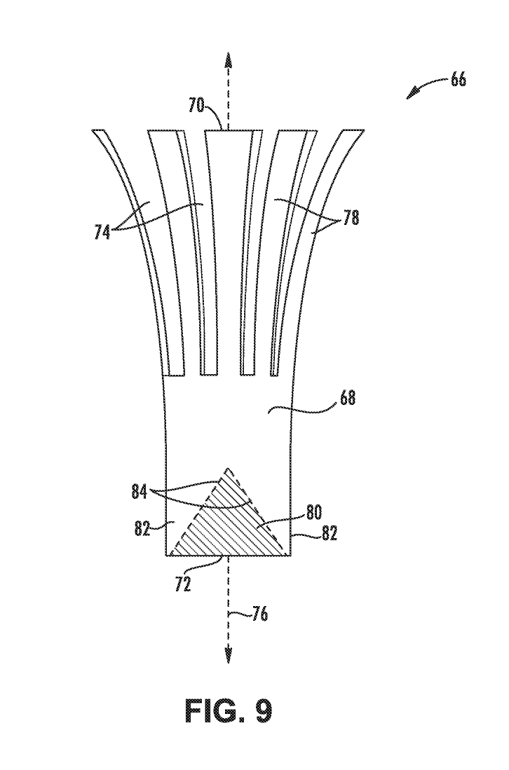

FIGS. 8 and 9 show a related embodiment of an unfinished endodontic instrument 66 including a base cylinder 68 having a proximal end 70 and a distal end 72. The instrument 66 further includes a plurality of elongated apertures 74 oriented substantially along the length axis 76 of the instrument 66 and from the proximal end 70 of the base 68, thereby defining a plurality of arms 78. The arms 78 have been bent outward after a plunging step as illustrated, for example, in FIG. 5. In this embodiment, shaded regions 80 are shown where portions of the base 68 are cut away from the base 68 and the remaining flaps 82 may be pressed together and attached along flap edges 84, such as by welding, to form a tip.

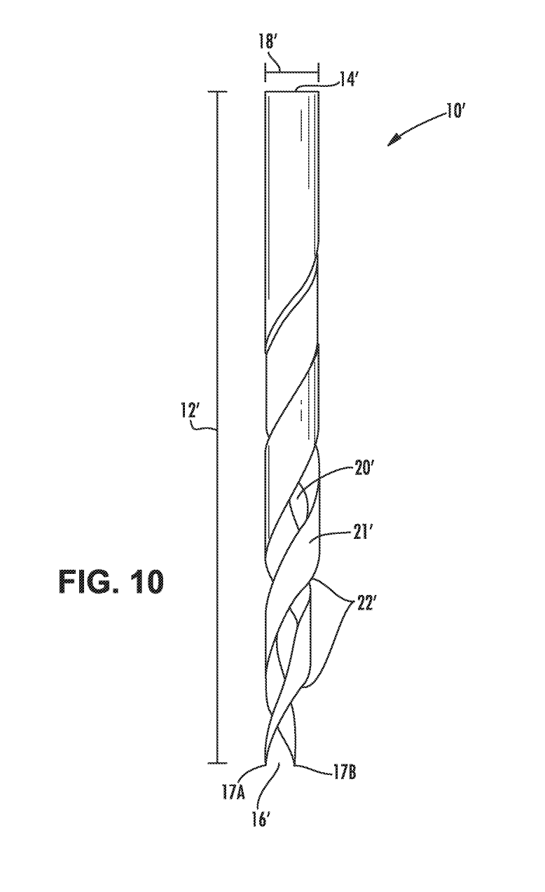

FIG. 10 shows an endodontic instrument 10′ similar to the endodontic instrument 10 shown in FIGS. 1-2. However, rather than including a single notch, the instrument 10′ is preferably formed by cutting a plurality of substantially V-shaped notches from the hollow cylinder to form multiple channels 20′ and multiple lands 21′, the edges of which define cutting edges 22′. The lands extend to the distal end 16′ of the instrument at a plurality of end tips 17A and 17B.

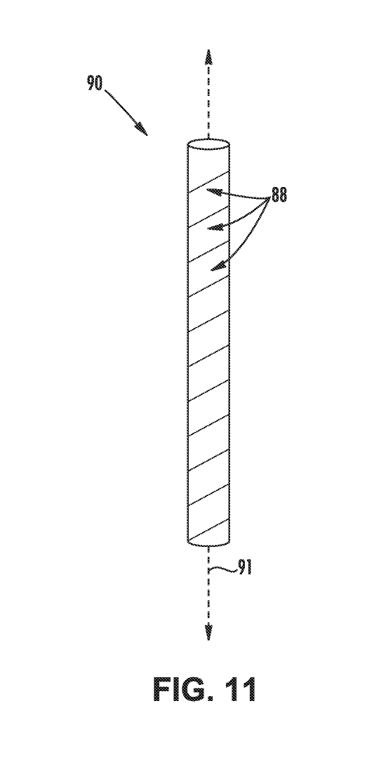

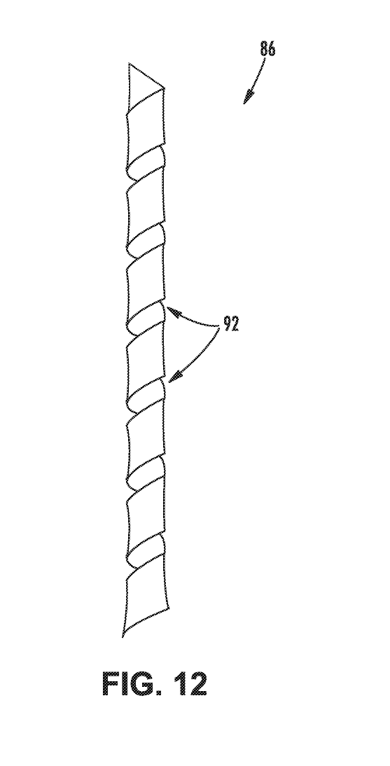

Another embodiment including an elongated slit 88 is shown in FIGS. 11 and 12. The instrument 86 is preferably made by cutting one or more slits 88 in spiral fashion along the lengthwise dimension of a tube 90. The tube 90 is then stretched along its length axis 91 to create spaces between edges 92 of the slit 88. The stretched tube 90 may then be set in shape, such as by heating the stretched tube to set the new stretched shape. The stretched tube may be used as an endodontic instrument wherein the edges 92 act as cutting surfaces. In certain embodiments, during the heating step, the edges 92 preferably flare outward and become more efficient in extirpation of material from the walls of a canal during an endodontic procedure. Alternately, the instrument may be formed by simply cutting a spiral helical slot along the entire length of the tube 90. Additionally, a handle (not shown) would preferably be attached to one end of the stretched tube 90.

In various embodiments described herein, additional sub-slits may be cut along the hollow tube. For example, sub-slits may be formed between the spirals of the slit 88 to, for example, increase potential cutting edges and to increase the flexibility of the tube. These sub-slits may be cut in substantially the same direction as slit 88. The sub-slits do not extend to either end of the hollow tube and are preferably shorter than, for example, the notch defined as a pattern 26 shown in FIG. 1, the V-shaped notches (wrapped around the hollow tube) shown in FIG. 10, or the slit 88 shown in FIGS. 11-12.

The above embodiments may all be formed from a tubular blank, wherein apertures or slots may be formed in the tube by cutting or other various methods. Cutting of such apertures, slots, and various other portions of the endodontic instruments described is preferably accomplished using a laser. One preferred laser is a femtolaser, which operates at a very high pulse rate with pulses of short duration. Femtolasers are believed to limit heat creation in the tube material and avoid heat-related changes to material properties. However, in alternate embodiments, the instruments of the present invention may be manufactured using electrical discharge machining, water jet cutters, grinding methods, or other suitable manufacturing methods.

It is thought that debris accumulating in the flutes of conventional endodontic instruments account for up to about 50% of the torque exerted on the instrument. By providing an endodontic instrument with a hollow interior, accumulation of debris in the endodontic instruments and canal is limited, since there are no traditional flutes within which debris can become clogged. This characteristic is particularly helpful in embodiments in which debris is actively removed from the hollow core of the instrument as discussed below.

In a preferred embodiment, an endodontic instrument as described above including a substantially hollow core may be attached to a rotary and/or reciprocating hand-piece or other device configured with an evacuation channel located in-line with the hollow core of the instrument, the evacuation channel for evacuating (e.g., by vacuum suction) liquids and other materials from the area where a dental operation is being performed. Thus, as tissue from the walls of the canal, bacteria, or other matter is removed from the canal by the cutting edges, the material is evacuated through channels, into the hollow core of the instrument, into the evacuation channel, and away from the area where an operation is being performed. Alternatively, the drill or other device attached to the endodontic instrument may include a channel for adding a fluid to a location where an operation is taking place such that a fluid could be introduced through the hollow core of the endodontic instrument to provide irrigation, potentially concurrently with an extirpation procedure.

In addition to various instruments and portions thereof, this disclosure includes a method for making an endodontic instrument including the steps of cutting a specifically shaped portion or portions out of a cylinder including a substantially hollow core (e.g., the cylinder 24 shown in FIG. 2). In a related embodiment, the method further includes plunging a plunger at least partially into the hollow core of a cylindrical tube to physically alter one or more features of the cylinder.

In one embodiment, the cylinder has been cut in such a way that a plurality of arms has been defined as shown, for example, in FIG. 4. A subsequent plunging step may include plunging a plunger at least partially into the hollow core of the cylinder to force the plurality of arms outward from the hollow core. After the arms have been moved in an outward orientation from the hollow core, a subsequent step may include attaching a brace 52 to the ends 54 of the arms 48, such as by welding.

An additional step may include attaching a cutting tip 56 to the distal end 40 of the cylindrically-shaped base 42. Alternatively, an additional step may include cutting portions of the cylindrically-shaped base 42 off of the base 42 leaving a plurality of flaps 82. Subsequently, the flaps 82 may be forced toward one another so that the flap edges 84 (or portions thereof) may be attached together by welding, for example.

The instruments and methods described above are preferably used in endodontic procedures such as, for example, root canal extirpation. The instruments can be used in a manner the same as or similar to traditional endodontic files by rotating the instrument within the canal such that the cutting edges remove material from the walls of the canal. The previously described embodiments of the present disclosure are believed to have many advantages over traditional instruments, including simplicity of manufacturing, greater tolerance to fatigue due in part to the hollow nature of the instrument, less susceptibility to fracture when relatively high torque stresses are applied to the instrument, and increased flexibility in part because of the hollow structure of the instrument. For example, when a traditional endodontic instrument is used to remove material from an infected root canal, interior tooth material often becomes lodged into grooves between cutting surfaces along the outer surface of the instrument, causing the instrument to, in effect, jam or otherwise become mired in a particular portion of a tooth. This jamming may result in the fracture of the instrument because of the rapid increase in torque stress. When an instrument as disclosed herein is used, the tooth material has room to move out of the canal through the interior hollow portion of the instrument, decreasing the likelihood of jamming to occur.

In some embodiments of the invention, a hydrophobic coating may be applied to the interior and/or the exterior of the instrument to facilitate debris removal and irrigation.

Furthermore, instruments of the present invention may also be used for obturation to assist in filling the canal or for other purposes in endodontic and dental procedures.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. An endodontic instrument for use in a root canal procedure, the instrument comprising a substantially hollow tube including at least one elongate slotted aperture extending along a working portion of the tube, wherein one or more edges defining the slotted aperture provide cutting surfaces for extirpating material from the wails of a root canal.

2. The endodontic instrument of claim 1 comprising a plurality of substantially parallel slotted apertures formed along the working portion of the tube.

3. The endodontic instrument of claim 1, wherein the slotted aperture extends helically along the working portion of the tube.

4. The endodontic instrument of claim 1 wherein the aperture extends from a first end of the tube to adjacent a second end of the tube.

5. The endodontic instrument of claim 4, wherein the slotted aperture comprises a tapered slot which decreases in width from the first end of the tube substantially to a point adjacent the second end of the tube.

6. The endodontic instrument of claim 5, comprising a plurality of tapered slotted apertures extending from the first end to adjacent the second end of the tube.

7. The endodontic instrument of claim 5, wherein the slotted aperture extends substantially helically along the working portion of the tube.

8. The endodontic instrument of claim 2, wherein land portions of the hollow tube disposed between the plurality of slotted apertures taper outwardly from the center axis of the tube such that the instrument is substantially tapered from a first end to adjacent a second end.

9. The endodontic instrument of claim 8, wherein a cutting tip is disposed on the second end of the instrument.

10. The endodontic instrument of claim 1, further comprising a handle to facilitate manual manipulation of the instrument or connection to an automated rotary or reciprocating device.

11. The endodontic instrument of claim 1, wherein the instrument is formed from a stainless steel material or nickel-titanium alloy.

12. The endodontic instrument of claim 1 further comprising a hydrophobic coating applied to a portion of the instrument to assist with extirpation or irrigation of the canal.

13. An endodontic instrument for use in a root canal procedure, the instrument comprising a substantially hollow cylindrical tube including at least one tapered elongate slot extending along a first portion of the length of the tube from a distal end of tube to adjacent a proximal end, wherein the width of the slot increases from adjacent the proximal end to the distal end such that the hollow cylindrical tube comprises a tapered land which decreases in width from adjacent the proximal end to a point at the distal end of the tube.

14. A method of manufacturing an endodontic instrument, the method comprising the step of cutting an elongate slotted aperture along a portion of the length of a substantially cylindrical, substantially hollow tube.

15. The method of claim 13, wherein the elongate slotted aperture is cut from the cylindrical hollow tube using laser cutting.

16. The method of claim 13, wherein the cutting step is performed using a process selected from the group consisting of laser cutting, water jet cutting, mechanical grinding, and electrical discharge machining.

17. The method of claim 13, Wherein the slotted aperture comprises a slit extending helically along the portion of the length.

18. The method of claim 13 wherein the cutting step further comprises cutting a plurality of substantially parallel slits into the tube wherein the slits extend from a proximal end of the tube to adjacent a distal end of the tube, wherein the slits further define a plurality of arms extending toward the proximal end of the tube.

19. The method of claim 8 further comprising the step of plunging a plunger into a hollow core of the tube causing the plurality of arms to taper outward from the hollow interior of the tube.

20. The method of claim 9 further comprising the step of attaching a brace to ends of at least two of the arms extending outward from the hollow interior of the tube.
